(19) United States
(12) Patent Application Publication
(10) Pub. No.: US 2017/0018389 A1
(43) Pub. Date: Jan. 19, 2017

(54) CIRCUIT PROTECTION ASSEMBLY

(71) Applicant: LITTELFUSE, INC., Chicago, IL (US)

(72) Inventor: Brent Glad, Bellingham, WA (US)

(73) Assignee: LITTELFUSE, INC., Chicago, IL (US)

(21) Appl. No.: 14/799,834

(22) Filed: Jul. 15, 2015

(51) Int. Cl. H01H 85/143; H01H 69/02

(52) U.S. Cl. CPC H01H 85/143; H01H 69/02

(57) ABSTRACT

A circuit protection assembly can include a conductive assembly post that supports a first conductive element, a non-conductive isolator, a second conductive element, a fuse, and a fastener. The first and second conductive elements can be positioned in close proximity to one another below the fuse. A first portion of the isolator can separate the first and second conductive elements. A second portion of the isolator can separate the conductive assembly post from the second conductive element. The first conductive element can be coupled to a power source and the second conductive element can be coupled to a downstream circuit. The fuse can protect the downstream circuit during specified overvoltage and/or overcurrent conditions and can be quickly and efficiently installed and replaced without the need to remove or reattach the conductive elements or any other cabling or wires.

### FIELD OF THE DISCLOSURE

Embodiments relate to the field of circuit protection devices, and more particularly to circuit protection assemblies that provide improved performance and less burdensome installation and maintenance.

### BACKGROUND OF THE DISCLOSURE

A fuse can be used as a circuit protection device and can provide an electrical connection between a power source and a circuit to be protected. The fuse can be designed to provide protection to the circuit during an overcurrent and/or an overvoltage condition. In particular, the fuse can be constructed to physically open or interrupt the electrical connection when a specified overcurrent and/or an overvoltage condition occurs, thereby isolating the circuit and preventing damage.

Fuses are often used in industrial settings such as in factories, heavy machinery, and vehicles. A common type of fuse often used in these settings are block-style or cube-style fuses. Conventional circuit protection assemblies that use these fuse styles are cumbersome to install and maintain, largely due to the need to detach and reattach cabling when replacing the fuses.

Accordingly, there is a need to provide a circuit protection assembly that uses cube-style fuses with improved ease of installation and maintenance.

### SUMMARY

Exemplary embodiments are directed to circuit protection assemblies and methods for using, operating, and maintaining the same. According to various embodiments, a circuit protection assembly includes a conductive assembly post that supports a first conductive element, a non-conductive isolator, a second conductive element, a fuse, and a fastener. The first and second conductive elements can be positioned in close proximity to one another below the fuse. A first portion of the isolator can separate the first and second conductive elements. A second portion of the isolator can separate the conductive assembly post from the second conductive element. The first conductive element can be coupled to a power source and the second conductive element can be coupled to a downstream circuit. The fuse can protect the downstream circuit during specified overvoltage and/or overcurrent conditions and can be quickly and efficiently installed and replaced without any need to remove or reattach the conductive elements or any other cabling or wires.

### BRIEF DESCRIPTION OF THE DRAWINGS

FIG. 1 illustrates a perspective view of a circuit protection assembly according to embodiments of the disclosure.

FIG. 2 illustrates a side view of the circuit protection assembly depicted in FIG. 1.

FIG. 3 illustrates a cut-away side view of the circuit protection assembly depicted in FIG. 1.

FIG. 4 illustrates a second cut-away side view of the circuit protection assembly depicted in FIG. 1.

FIG. 5 depicts an exemplary process flow in accordance with further embodiments.

### DETAILED DESCRIPTION

The present embodiments will now be described more fully hereinafter with reference to the accompanying drawings, where exemplary embodiments are shown. The embodiments should not be construed as limited to the embodiments set forth herein. These embodiments are provided so this disclosure will be thorough and complete, and will fully convey their scope to those skilled in the art. In the drawings, like numbers refer to like elements throughout.

In the following description and/or claims, the terms “on”, “overlying”, “disposed on”, and “over” may be used in the following description and claims. “On”, “overlying”, “disposed on”, and “over” may be used to indicate when two or more elements are in direct physical contact with one another. However, “on”, “overlying”, “disposed on”, and “over,” may also mean two or more elements are not in direct contact with one another. For example, “over” may mean one element is above another element but not contact one another and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

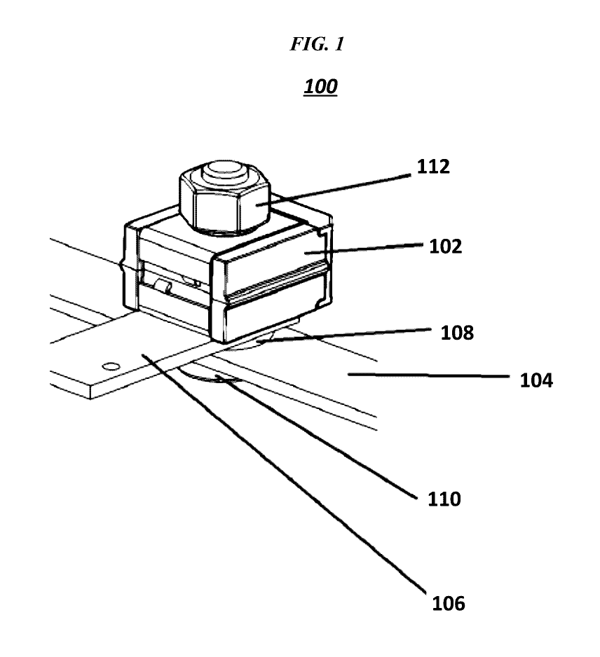

FIG. 1 illustrates a perspective view of a circuit protection assembly 100. The circuit protection assembly 100 can include a fuse 102, an input bus bar 104, an output bus bar 106, an isolator 108, a conductive assembly post 110, and a fastener 112.

The circuit protection assembly 100 can be considered to be a fuse assembly 100. The fuse 102 can be a block fuse or a cube-style fuse. As an example, the fuse 102 can be a CF8 or Zcase fuse manufactured by Littelfuse, Inc. In general, the fuse 102 can be any fuse that provides protection against overvoltage and/or overcurrent conditions. The fuse 102 can include an aperture to accommodate positioning on or around the conductive assembly post 110. The aperture of the fuse 102 can be a central aperture and can be of any size and shape. The fuse 102 can further include an input terminal and an output terminal. As an example, a top portion of the fuse 102 can provide the input terminal and a bottom portion of the fuse 102 can provide the output terminal, as more fully explained below.

The input bus bar 104 and the output bus bar 106 can be conductive elements (e.g., conductive input bus bar 104 and output bus bar 106, respectively). The input bus bar 104 and the output bus bar 106 can be made of a variety of materials including, for example, copper. The input bus bar 104 and the output bus bar 106 can provide power from a power source to a downstream circuit (not shown). The fuse 102, by being positioned between the input bus bar 104 and the output bus bar 106, can provide overvoltage and/or overcurrent protection to the downstream circuit.

As shown in FIG. 1, the input bus bar 104 and the output bus bar 106 are positioned to be orthogonal to one another but are not so limited. Further, the input bus bar 104 and the output bus bar 106 also each include an aperture to accommodate positioning on or around the conductive assembly post 110. The apertures of the input bus bar 104 and the output bus bar 106 can be central apertures and can be of any size and shape.

The isolator 108 can be a non-conductive element (e.g., a non-conductive isolator 108). As an example, the isolator 108 can be made of plastic and/or glass. The isolator 108 can be positioned between the input bus bar 104 and the output bus bar 106 so as to isolate the input bus bar 104 and the output bus bar 106 from one another electrically. In this way, the input bus bar 104 and the output bus bar 106 can be positioned in close proximity with one another without coming into contact. In particular, the isolator 108 enables the input bus bar 104 and the output bus bar 106 to both be positioned below the fuse 102 in close proximity to one another. The isolator 108 can include an aperture to accommodate positioning on or around the conductive assembly post 110. The aperture of the isolator 108 can be a central aperture and can be of any size and shape.

The conductive assembly post 110 can be considered to be a post or stud. The conductive assembly post 110 can include a head portion and a post portion. The conductive assembly post 110 can be a conductive element. As an example, the conductive assembly post 110 can be a copper stud. The conductive assembly post 110 can provide a support (e.g., the post portion) for the other components of the circuit protection assembly 100 to be assembled around or on. The post portion of the conductive assembly post 110 can be of any shape and size provided the post portion can support positioning or stacking of the other components of the circuit protection assembly 100. As an example, the post of the conductive assembly post 110 can be cylindrical.

The conductive assembly post 110 can be made from a variety of materials and can be formed from a single component or can be formed from multiple components (e.g., separate head and post portions). The conductive assembly post 110 can be coupled to additional structural components (not shown in FIG. 1).

The fastener 112 can be positioned at a top portion of the post of the conductive assembly post 110. The fastener 112 can be a conductive element (e.g., a conductive fastener 112) and can be made from a variety of materials. As an example, the fastener 112 can be a copper nut or copper bolt. A top portion of the post of the conductive assembly post 110 can be threaded to enable the fastener 112 to be fastened to the conductive assembly post 110. The fastener 112, in conjunction with the conductive assembly post 110, can support and retain the circuit protection assembly 100 by ensuring the close proximity and arrangement of the fuse 102, the input bus bar 104, the output bus bar 106, and the isolator 108. To do so, the fastener 112 can include an aperture to accommodate positioning on or around the conductive assembly post 110. The aperture of the fastener 112 can be a central aperture and can be of any size and shape.

The circuit protection assembly 100 provides efficient circuit protection with a compact structure that provides low complexity assembly/installation and maintenance/replacement. Specifically, the fuse 102 can be selected to provide a desired overvoltage and/or overcurrent protection to a downstream circuit (not shown in FIG. 1). Power provided by the input bus bar 104 to the output bus bar 106 can be disrupted as necessary and as designed based on operation of the fuse 102. As such, an overvoltage and/or overcurrent condition or event can be blocked by the fuse 102 and can be prevented from propagating to the downstream circuit.

By positioning both the input bus bar 104 and the output bus bar 106 beneath the fuse 102, the fuse 102 can be replaced and/or repaired with minimal disruption to the circuit protection assembly 100. For example, neither the input bus bar 104 nor the output bus bar 106 need to be removed or moved to allow access to the fuse 102. As such, the fuse 102 can be replaced quickly and efficiently by removing the fastener 112.

As an alternative to the input bus bar 104 and the output bus bar 106, the circuit protection assembly 100 can include other conductive elements such as, for example, wire cables. In general, the fuse 102 can be any device designed or constructed to physically open or interrupt a circuit path and isolate electrical components upon occurrence of specified overvoltage and/or overcurrent conditions. For example, the fuse 102 can interrupt a circuit path between the input bus bar 104 and the output bus bar 106 upon the occurrence of a predetermined overvoltage condition, thereby isolating and protecting a downstream circuit from exposure to the overvoltage condition.

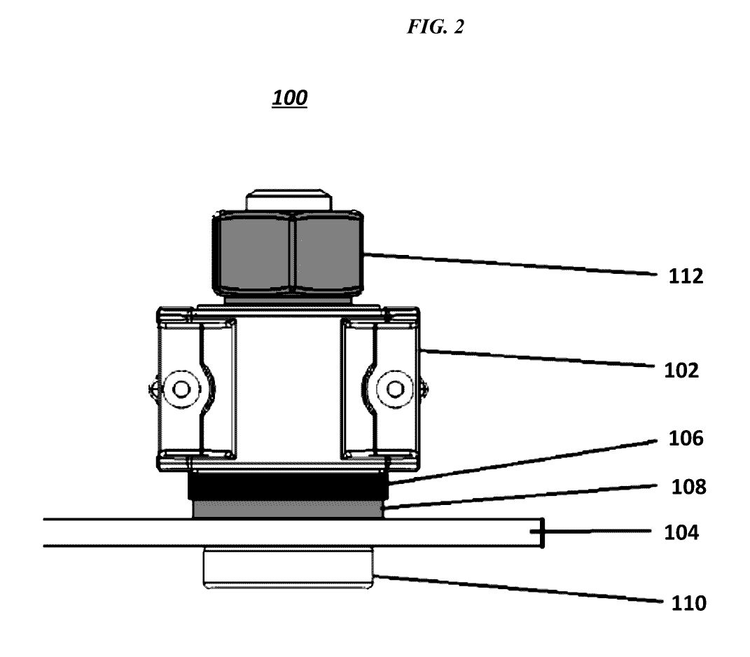

FIG. 2 illustrates a side view of the circuit protection assembly 100. As shown in FIG. 2, the conductive assembly post 110 provides a mounting for the other components of the circuit protection assembly 100. The other components of the circuit protection assembly 100 can be positioned on or around the post of the conductive assembly post 110. For example, the other components of the circuit protection assembly 100—the fuse 102, the input bus bar 104, the output bus bar 106, the isolator 108, and the fastener 112—can include apertures that accommodate positioning on the conductive assembly post 110. FIG. 2 illustrates the circuit protection assembly 100 “stack” or arrangement of the constituent components of the circuit protection assembly 100.

As shown in FIG. 2, the input bus bar 104 can be positioned first on the conductive assembly post 110 adjacent to the head of the conductive assembly post 110. The isolator 108 can be positioned next on the conductive assembly post 110 above the input bus bar 104. The output bus bar 106 can then be positioned next on the conductive assembly post 110. The fuse 102 can then be positioned on the conductive assembly post 110 above the output bus bar 106. As a last portion of the circuit protection assembly 100, the fastener 112 can be positioned on the conductive assembly post 110. As discussed above, the fastener 112 can be a copper nut that can be tightened down onto threads of the conductive assembly post 110 to ensure the components of the circuit protection assembly 100 are securely fastened to the conductive assembly post 110 and fit securely next to adjacent components.

As further shown in FIG. 2, to replace the fuse 102, the fastener 112 can be removed from the conductive assembly post 110 and the fuse 102 can be removed. Other components of the circuit protection assembly 100 need not be disturbed to facilitate maintenance or replacement of the fuse 102. This simplifies installation and maintenance of the circuit protection assembly 100 compared to conventional circuit protection assemblies.

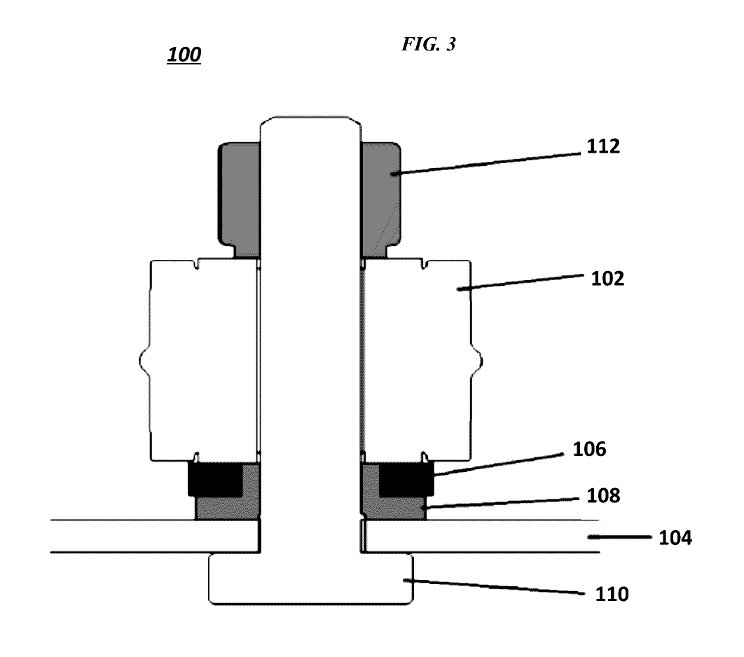

FIG. 3 illustrates a cut-away side view of the circuit protection assembly 100. As shown in FIG. 3, the conductive assembly post 110 can be directly coupled or connected to the input bus bar 104. The input bus bar 104 can be positioned adjacent to the head of the conductive assembly post 110 and/or adjacent to the post of the conductive assembly post 110. The isolator 108 can be positioned adjacent to the input bus bar 104. The output bus bar 106 can be positioned adjacent to the isolator 108. As shown in FIG. 3, the isolator 108 can physically separate the input bus bar 104 from the output bus bar 106. Additionally, the isolator 108 can physically separate the output bus bar 106 from the conductive assembly post 110. The fuse 102 can be positioned on top of the output bus bar 106 and the isolator 108. A top of the output bus bar 106 and a top of the isolator 108 can be approximately aligned and/or approximately co-planar but are not so limited. When so aligned, the top of the output bus bar 106 and the top of the isolator 108 can provide an approximately flat or level support for a bottom of the fuse 102.

The isolator 108 can be of a variety of shapes and sizes to isolate the input bus bar 104 from the output bus bar 106 and to isolate the conductive assembly post 110 from the output bus bar 106. The isolator can include a first portion for isolating the input bus bar 104 from the output bus bar 106 and a second portion for isolating the fuse 102 from the output bus bar 106. The first portion of the isolator 108 can be wider than the second portion of the isolator 108 as shown in FIG. 3. As shown in FIG. 3, a vertical thickness (e.g., relative to the orientation of the conductive assembly post 110) of the first portion of the isolator 108 can separate the input bus bar 104 from the output bus bar 106. A horizontal thickness (e.g., relative to the orientation of the conductive assembly post 110) of the second portion of the isolator 108 can separate the conductive assembly post 110 from the output bus bar 106. The first and second portions of the isolator 108 can be made from separate components or can be formed from a single component.

As further shown in FIG. 3, the fuse 102 is positioned over the output bus bar 106 and the isolator 108. The fuse can be directly coupled to the output bus bar 106. Further, the fuse 102 can be directly coupled to the fastener 112 which can be positioned over the fuse 102.

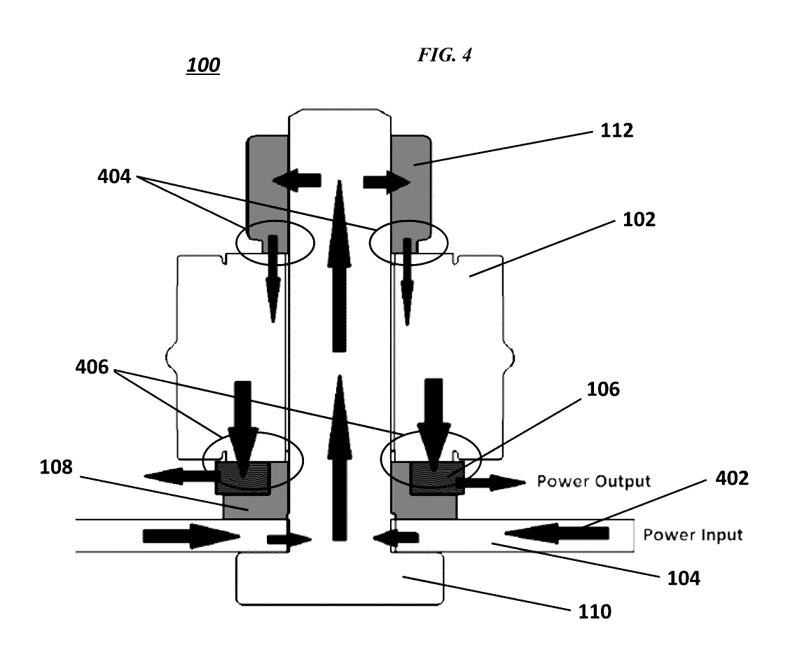

FIG. 4 illustrates a further cut-away side view of the circuit protection assembly 100 showing a current flow 402. Specifically, FIG. 4 shows an approximate exemplary current flow direction from the input bus bar 104 to the conductive assembly post 110, from the conductive assembly post 110 to the fastener 112, from the fastener 112 to the fuse 102, and then from the fuse 102 to the output bus bar 106. The current flow 402 as shown can be disrupted by the fuse 102 as desired.

The current flow from the fastener 112 to the fuse 102 can be provided by way of an input terminal 404 of the fuse 102. The input terminal 404 of the fuse 102 can positioned approximately at a location where a portion of a lower surface of the fastener 112 makes contact with a portion of an upper surface of the fuse 102.

The current flow from the fuse 102 to the output bus bar 106 can be provided by way of an output terminal 406 of the fuse 102. The output terminal 406 of the fuse 102 can be positioned approximately at a location where a portion of a lower surface of the fuse 102 makes contact with a portion of an upper surface of the output bus bar 106.

As a result of the arrangement of the circuit protection assembly 100 components depicted in FIG. 4, a circuit is formed between the input bus bar 104 and the output bus bar 106 comprising the conductive assembly post 110, the fastener 112, and the fuse 102. The input bus bar 104 can be considered a power input (e.g., a power input terminal) and the output bus bar 106 can be considered a power output (e.g., a power output terminal).

The positioning of the isolator 108 as shown in FIG. 4 ensures that the current flow 402 is as shown during normal operation. Specifically, the isolator 108 prevents the current flow 402 from passing from the conductive assembly post 110 directly to the output bus bar 106 and prevents the current flow 402 from passing from the input bus bar 104 directly to the output bus bar 106. Further, the arrangement of the input terminal 404 and the output terminal 406 of the fuse 102 ensures that the current flow 402 passes through the fuse 102 appropriately from the fastener 112 to the output bus bar 106.

When the fuse 102 detects and responds to an overvoltage and/or overcurrent condition, the fuse 102 can disrupt the current flow 402. Specifically, the fuse 102 can prevent the current flow 402 between the input terminal 404 and the output terminal 406 so that the current flow 402 to the output bus bar 106 is disrupted. In this way, power to a downstream circuit can be disrupted (i.e., the downstream circuit can be electrically decoupled or disconnected from connectivity with the input bus bar 104) in order to protect the downstream circuit.

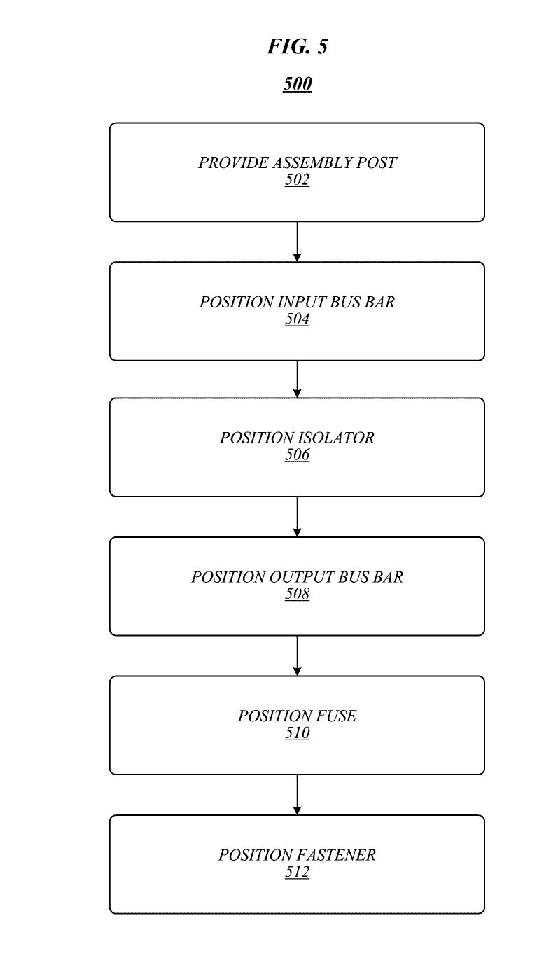

FIG. 5 depicts an exemplary process flow 500 in accordance with further embodiments. The exemplary process flow 500 can provide a method for using a circuit protection assembly, such as the circuit protection assembly 100. At block 502, an assembly post is provided. The assembly post can be a conductive assembly post. At block 504, an input bus bar is positioned on the assembly post. In general, the input bus bar can be a conductive element. As an alternative to a bus bar, the input conductive element can be a cable or a wire. The input bus bar can be positioned adjacent to a head portion of the assembly post and/or adjacent to the post portion of the assembly post.

At block 506, an isolator is positioned on the assembly post. The isolator can be positioned directly on top of the output bus bar and/or adjacent to the post portion of the assembly post.

At block 508, an output bus bar is positioned on the assembly post. In general, the output bus bar can be a conductive element. As an alternative to a bus bar, the output conductive element can be a cable or a wire. The output bus bar can be positioned on the isolator and can be physically and electrically separated from the assembly post and the input bus bar. As an example, the isolator can be positioned such that a first portion of the isolator can physically separate the input bus bar from the output bus bar. A second portion of the isolator can physically separate the assembly post from the output bus bar. Upper surfaces (or portions thereof) of the output bus bar and the isolator can be approximately aligned.

At block 510, a fuse can be positioned on top of the output bus bar. The fuse can also be positioned on top of the isolator. As an example, a bottom surface of the fuse can rest on top of aligned upper surfaces of the output bus bar and the isolator. An output terminal of the fuse can be positioned over or aligned with the output bus bar such that the output terminal is coupled to the output bus bar.

At block 512, a fastener is positioned over the fuse and on the assembly post. The fastener can be secured to the assembly post. As an example, a top portion of the post portion of the assembly post can be threaded to provide a securing mechanism for the fastener. As an example, the fastener can be a nut. An input terminal of the fuse can be aligned or adjacent with a portion of a bottom surface of the fastener such that the input terminal is coupled to the fastener.

The input bus bar, the isolator, the output bus bar, the fuse, and the fastener can each include apertures (e.g., central apertures) to accommodate positioning on or around the assembly post. The apertures can be of any size and shape to provide secure arrangement on the post portion of the assembly post. The post portion of the assembly post can have a shape corresponding to the apertures of the other components so as to ensure a secure fitting of the circuit protection assembly components.

Further to the process flow depicted in FIG. 5, the input bus bar can be coupled to a power source and the output bus bar can be coupled to a circuit (e.g., a downstream circuit). In doing so, the process flow 500 provides a circuit or current path comprising the input bus bar, the assembly post, the fastener, the fuse, and the output bus bar. Additionally, the process flow 500 can include the fuse responding to an overvoltage and/or overcurrent condition. As an example, in response to an overvoltage and/or overcurrent condition, the fuse can provide an open circuit and/or can disrupt a current path between the fastener and the output bus bar, thereby electrically isolating and protecting the downstream circuit that is coupled to the output bus bar.

The process flow 500 can also provide for maintenance of the circuit protection assembly. As an example, to replace the fuse (e.g., after the fuse responds to an overvoltage and/or an overcurrent condition), the fastener can be removed. A new or replacement fuse can then be positioned on the assembly post and secured with the fastener. In maintaining the circuit protection assembly to replace a fuse, the input and output bus bars do not need to be disturbed or removed from the assembly post.

While the present embodiments have been disclosed with reference to certain embodiments, numerous modifications, alterations and changes to the described embodiments are possible without departing from the sphere and scope of the present disclosure, as defined in the appended claims. Accordingly, it is intended the present embodiments not be limited to the described embodiments, and instead has the full scope defined by the language of the following claims, and equivalents thereof.

1. A circuit protection assembly, comprising:
a conductive assembly post;
a first conductive element positioned around the conductive assembly post;
a non-conductive isolator positioned on the first conductive element and around the conductive assembly post;
a second conductive element positioned on the non-conductive isolator;
a fuse positioned on the second conductive element and around the conductive assembly post; and
a conductive fastener positioned on the fuse and around the conductive assembly post.

2. The circuit protection assembly of claim 1, wherein a first portion of the non-conductive isolator separates the conductive assembly post from the second conductive element.

3. The circuit protection assembly of claim 2, wherein a second portion of the non-conductive isolator separates the first conductive element from the second conductive element.

4. The circuit protection assembly of claim 1, wherein a portion of a bottom surface of the conductive fastener is coupled to a first terminal of the fuse.

5. The circuit protection assembly of claim 4, wherein the first terminal of the fuse is an input terminal positioned on a portion of a top surface of the fuse.

6. The circuit protection assembly of claim 4, wherein a portion of a top surface of the second conductive element is coupled to a second terminal of the fuse.

7. The circuit protection assembly of claim 6, wherein the second terminal of the fuse is an output terminal positioned on a portion of a bottom surface of the fuse.

8. The circuit protection assembly of claim 1, wherein a portion of a top surface of the non-conductive isolator and a portion of a top surface of the second conductive element are approximately aligned.

9. The circuit protection assembly of claim 8, wherein a portion of a bottom surface of the fuse is positioned on the approximately aligned surfaces of the non-conductive isolator and the second conductive element.

10. The circuit protection assembly of claim 1, wherein the first conductive element is an input bus bar and the second conductive element is an output bus bar.

11. The circuit protection assembly of claim 1, wherein the first conductive element is an input cable and the second conductive element is an output cable.

12. The circuit protection assembly of claim 1, wherein the conductive assembly post is a copper bolt.

13. A method, comprising:
providing a conductive assembly post;
positioning a conductive input bus bar on the conductive assembly post;
positioning an isolator on the conductive assembly post;
positioning a conductive output bus bar on the isolator;
positioning a fuse on the conductive assembly post; and
positioning a fastener on the conductive assembly post on a top surface of the fuse.

14. The method of claim 13, further comprising coupling the conductive input bus bar to a power source and coupling the conductive output bus bar to a circuit.

15. The method of claim 13, further comprising positioning a first portion of the isolator to electrically isolate the conductive assembly post from the conductive output bus bar.

16. The method of claim 15, further comprising positioning a second portion of the isolator to electrically isolate the conductive input bus bar from the conductive output bus bar.

17. The method of claim 13, further comprising coupling an input terminal of the fuse to a bottom portion of the fastener.

18. The method of claim 13, further comprising coupling an output terminal of the fuse to an upper portion of the conductive output bus bar.

19. The method of claim 13, further comprising positioning the conductive output bus bar on the isolator.

20. The method of claim 19, further comprising aligning a top surface of the isolator with a top surface of the conductive output bus bar and positioning the fuse on the aligned top surfaces.
